(19) United States
(12) Patent Application Publication
(10) Pub. No.: US 2026/0319500 A1
(43) Pub. Date: Oct. 15, 2026

(54) METHOD AND APPARATUS FOR CONTROLLING MOVEMENT OF ROBOT USING ELEVATOR

(71) Applicants: HYUNDAI MOTOR COMPANY, Seoul (KR); Kia Corporation, Seoul (KR); SUNGSHIN WOMEN’S UNIVERSITY R&DB FOUNDATION, Seoul (KR)

(72) Inventors: Won Hee KIM, Hwaseong-si (KR); Jaehoon YOU, Hwaseong-si (KR); Soomin SHIM, Hwaseong-si (KR); Seong Wook HWANG, Seoul (KR); Joon Young KIM, Seoul (KR); Namgyo KIM, Chuncheon-si (KR); Young Eun KIM, Bucheon-si (KR); Bo Kyung KIM, Daejeon (KR); Gyeongbin RYOO, Seoul (KR); Jeong Min OH, Seoul (KR); Ji Soo KANG, Seoul (KR)

(21) Appl. No.: 19/377,631

(22) Filed: Nov. 3, 2025

(30) Foreign Application Priority Data
Apr. 10, 2025 (KR) 10-2025-0046559

(51) Int. Cl. G05D 1/467; G01G 19/52; G05D 1/249; G05D 105/70; G05D 107/50; G05D 109/10; G05D 111/10; G06T 7/70

(52) U.S. Cl. CPC G05D 1/467; G01G 19/52; G05D 1/249; G06T 7/70; G05D 2105/70; G05D 2107/50; G05D 2109/10; G05D 2111/17; G06T 2207/20081; G06T 2207/20084

(57) ABSTRACT

A method for controlling movement of a robot at an elevator includes: obtaining first sensing data of an internal space of the elevator using a camera sensor of the elevator and a weight sensor of the elevator; determining whether the robot is permitted to board the elevator based on the first sensing data; obtaining second sensing data of the internal space of the elevator using a lidar sensor disposed at the robot; based on the robot boarding the elevator, determining a first boardable area for the robot based on the first sensing data and the second sensing data; determining a second boardable area for the robot from the first boardable area based on a weight distribution of the internal space of the elevator; determining boarding position coordinates of the robot from the second boardable area; and controlling the movement of the robot based on the boarding position coordinates.

### CROSS-REFERENCE TO RELATED APPLICATION

This application claims priority to and the benefit of Korean Patent Application No. 10-2025-0046559, filed with the Korean Intellectual Property Office, on Apr. 10, 2025, the entire contents of which are incorporated herein by reference.

### TECHNICAL FIELD

The present disclosure relates to a method and apparatus for controlling movement of robot at an elevator.

### BACKGROUND

An autonomous driving robot technology may be used in various industrial and service fields along with recent developments in artificial intelligence and sensor technology.

For example, an autonomous driving robot may utilize sensors such as LiDAR, radar, ultrasonic sensors, and cameras to recognize the surrounding environment, detect obstacles, and perform path planning and movement control based on the recognized surrounding environment and detected obstacles.

The autonomous driving robot may use an elevator to move between floors in a building.

In some cases, while a method may rely on the robot's own sensor to determine whether a robot boards an elevator and boards at a preset position, the method may not provide boarding control of the robot by reflecting an internal state of the elevator.

In some cases, when an object inside the elevator moves, it may be difficult for the robot to automatically adjust the appropriate position, and a load imbalance may occur, where the robot movement control corresponding to the dynamic environment may be insufficient.

### SUMMARY

The present disclosure describes a method for controlling a robot in an environment where the elevator is used by the robot, so that more stable elevator operation is possible by considering riding with other objects.

The present disclosure describes a method of controlling movement of a robot by determining whether the robot is permitted to board an elevator by using a camera sensor and a weight sensor mounted on the elevator, determining a boardable area of the robot by further using a lidar sensor mounted on the robot, and referring to boarding position coordinates determined by considering a weight distribution of the object included in the elevator from the boardable area of the robot.

According to one aspect of the subject matter described in this application, a method for controlling movement of a robot at an elevator includes: obtaining first sensing data of an internal space of the elevator using a camera sensor of the elevator and a weight sensor of the elevator; determining whether the robot is permitted to board the elevator based on the first sensing data; obtaining second sensing data of the internal space of the elevator using a lidar sensor disposed at the robot; based on the robot boarding the elevator, determining a first boardable area for the robot based on the first sensing data and the second sensing data; determining a second boardable area for the robot from the first boardable area based on a weight distribution of the internal space of the elevator; determining boarding position coordinates of the robot from the second boardable area; and controlling the movement of the robot based on the boarding position coordinates.

Implementations according to this aspect can include one or more of the following features. For example, determining whether the robot is permitted to board the elevator can include comparing a sum of a weight of one or more objects in the elevator acquired using the weight sensor and a weight of the robot, with a weight capacity of the elevator to thereby determine whether the robot is permitted to board the elevator.

In some implementations, determining whether the robot is permitted to board the elevator can include determining a category and a position of the one or more objects from an image of the one or more objects acquired using the camera sensor of the elevator; and determining whether the robot is permitted to board the elevator based on the category and the position of the one or more objects. In some examples, the category and the position of the one or more objects can be determined through a pre-trained object detection model based on a training image for the one or more objects and a pose and an angle of the camera sensor.

In some implementations, determining whether the robot is permitted to board the elevator can include determining whether at least one boarding-waiting object is present for boarding the elevator, based on the at least one boarding-waiting object being present for boarding the elevator, estimating a weight of the at least one boarding-waiting object using a camera sensor disposed at the robot, and comparing a sum of the weight of the at least one boarding-waiting object, the weight of the object in the elevator, and the weight of the robot with the weight capacity of the elevator to thereby determine whether the robot is permitted to board the elevator.

In some implementations, determining the first boardable area can include determining, using the lidar sensor of the robot, a distance between the robot and an object in the elevator, determining a position of the object in the elevator based on the distance between the robot and the object, and determining the first boardable area based on the position of the object and a category of the object.

In some implementations, a floor area of the internal space of the elevator includes at least one weight sensing area having a preset size, where determining the second boardable area can include measuring object weights in each of the at least one weight sensing area, and determining, from the first boardable area, a region of the floor area corresponding to a weight that is less than an average or a minimum of the object weights.

In some implementations, controlling the movement of the robot can include determining boardable position coordinates of the robot such that centers of gravity of one or more objects in the elevator and the robot fall within a central area of the elevator, and determining, from among the boardable position coordinates, position coordinates that are included in the second boardable area, as the boarding position coordinates of the robot. In some examples, determining the boarding position coordinates can include determining the boarding position coordinates of the robot based on (i) a disembarking floor of the robot and (i) a disembarking floor of the elevator that is previously input.

In some implementations, controlling the movement of the robot can include providing robot movement information to an object in the elevator through at least one of a speaker or a display disposed at the robot, the robot movement information including (i) a movement path to the boarding position coordinates of the robot and (ii) a disembarking floor of the robot.

According to another aspect, an apparatus for controlling movement of a robot at an elevator includes a processor and a memory storing a robot movement control program configured to, based on being executed by the processor, cause the apparatus to perform operations. The operations include obtaining first sensing data of an internal space of the elevator using a camera sensor of the elevator and a weight sensor of the elevator, determining whether the robot is permitted to board the elevator based on the first sensing data, obtaining second sensing data of the internal space of the elevator using a lidar sensor disposed at the robot, based on the robot boarding the elevator, determining a first boardable area for the robot based on the first sensing data and the second sensing data, determining a second boardable area for the robot from the first boardable area based on a weight distribution of the internal space of the elevator, determining boarding position coordinates of the robot from the second boardable area, and controlling the movement of the robot based on the boarding position coordinates.

Implementations according to this aspect can include one or more of the following features, where the operations can provide the method describe above.

determining whether the robot is permitted to board the elevator can include comparing a sum of a weight of one or more objects in the elevator acquired using the weight sensor and a weight of the robot, with a weight capacity of the elevator to thereby determine whether the robot is permitted to board the elevator.

In some implementations, determining whether the robot is permitted to board the elevator can include determining a category and a position of the one or more objects from an image of the one or more objects acquired using the camera sensor of the elevator; and determining whether the robot is permitted to board the elevator based on the category and the position of the one or more objects.

In some implementations, determining whether the robot is permitted to board the elevator can include determining whether at least one boarding-waiting object is present for boarding the elevator, based on the at least one boarding-waiting object being present for boarding the elevator, estimating a weight of the at least one boarding-waiting object using a camera sensor disposed at the robot, and comparing a sum of the weight of the at least one boarding-waiting object, the weight of the object in the elevator, and the weight of the robot with the weight capacity of the elevator to thereby determine whether the robot is permitted to board the elevator.

In some implementations, determining the first boardable area can include determining, using the lidar sensor of the robot, a distance between the robot and an object in the elevator, determining a position of the object in the elevator based on the distance between the robot and the object, and determining the first boardable area based on the position of the object and a category of the object.

In some implementations, a floor area of the internal space of the elevator includes at least one weight sensing area having a preset size, where determining the second boardable area can include measuring object weights in each of the at least one weight sensing area, and determining, from the first boardable area, a region of the floor area corresponding to a weight that is less than an average or a minimum of the object weights.

In some implementations, controlling the movement of the robot can include determining boardable position coordinates of the robot such that centers of gravity of one or more objects in the elevator and the robot fall within a central area of the elevator, and determining, from among the boardable position coordinates, position coordinates that are included in the second boardable area, as the boarding position coordinates of the robot. In some examples, determining the boarding position coordinates can include determining the boarding position coordinates of the robot based on (i) a disembarking floor of the robot and (i) a disembarking floor of the elevator that is previously input.

In some implementations, controlling the movement of the robot can include providing robot movement information to an object in the elevator through at least one of a speaker or a display disposed at the robot, the robot movement information including (i) a movement path to the boarding position coordinates of the robot and (ii) a disembarking floor of the robot.

According to another aspect, a non-transitory computer-readable recording medium stores a computer program, where the computer program includes instructions configured to, based on being executed by a processor, cause the processor to perform operations for controlling movement of a robot at an elevator. The operations include obtaining first sensing data of an internal space of the elevator using a camera sensor of the elevator and a weight sensor of the elevator, determining whether the robot is permitted to board the elevator based on the first sensing data, obtaining second sensing data of the internal space of the elevator using a lidar sensor disposed at the robot, based on the robot boarding the elevator, determining a first boardable area for the robot based on the first sensing data and the second sensing data, determining a second boardable area for the robot from the first boardable area based on a weight distribution of the internal space of the elevator, determining boarding position coordinates of the robot from the second boardable area, and controlling the movement of the robot based on the boarding position coordinates.

### BRIEF DESCRIPTION OF THE DRAWINGS

FIG. 1 is a block diagram illustrating an example of an apparatus for controlling movement of a robot.

FIG. 2 is a block diagram conceptually illustrating an example of a function of a robot movement control program.

FIG. 3 is a flowchart illustrating an example of a method for controlling movement of a robot at an elevator.

FIG. 4 is a diagram illustrating an example of a structure of an elevator boarding control system.

FIG. 5 is a diagram illustrating an example of determining whether a robot is permitted to board an elevator and determining a boardable area of the robot.

FIG. 6 is a diagram illustrating an example of controlling movement of a robot by referring to boardable position coordinates of the robot in which a center area of the elevator is determined to include centers of gravity of an object and the robot included in the elevator.

FIG. 7 is a diagram illustrating an example of determining a position of an object included in an elevator and a weight distribution of the object through linkage between the elevator and an elevator boarding control platform.

FIG. 8 is a diagram illustrating an example of re-determining the position of the object included in the elevator through linkage between the robot and the elevator boarding control platform.

FIG. 9 is a diagram illustrating an example of controlling the movement of the robot using the elevator based on the linkage between the elevator, the robot, and the elevator boarding control platform.

### DETAILED DESCRIPTION

Various advantages and features of the present disclosure and methods accomplishing them will become apparent from the following description of example implementations with reference to the accompanying drawings. However, the present disclosure is not limited to example implementations to be described below, but can be implemented in various different forms, these example implementations will be provided only in order to make the present disclosure complete and allow those skilled in the art to recognize the scope of the present disclosure, and the present disclosure will be defined by the scope of the claims.

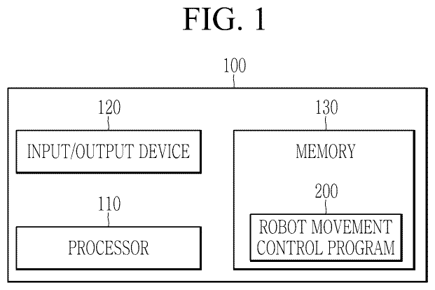

FIG. 1 is a block diagram illustrating an apparatus for controlling movement of a robot.

Referring to FIG. 1, an apparatus 100 for controlling movement of a robot can include a processor 110, an input/output device 120, and a memory 130.

The processor 110 can control the overall operation of the apparatus 100 for controlling movement of a robot.

The processor 110 can receive sensing data for an internal space of an elevator in a building using the input/output device 120.

Specifically, the processor 110 can receive first sensing data for the internal space of the elevator using a camera sensor and a weight sensor of the elevator.

In addition, the processor 110 can receive second sensing data for the internal space of the elevator using a lidar sensor of the robot.

In this specification, for convenience of description, it has been described that the sensing data for the internal space of the elevator in the building is input through the input/output device 120, but is not limited thereto. That is, the apparatus 100 for controlling movement of a robot can include a transceiver and can receive the sensing data for the internal space of the elevator in the building using the transceiver, and the sensing data for the internal space of the elevator in the building can be collected or generated within the apparatus 100 for controlling movement of a robot.

The processor 110 can determine whether the robot is on board using the sensor mounted on the elevator, determine a boardable area of the robot using the sensor mounted on the robot, and control the movement of the robot by referring to the boarding position coordinates of the robot determined by considering a weight distribution in the internal space of the elevator.

The input/output device 120 can include one or more input devices and/or one or more output devices. For example, the input device can include a microphone, a keyboard, a mouse, a touch screen, and the like, and the output device can include a display, a speaker, and the like.

The memory 130 can store a robot movement control program 200 and information for executing the robot movement control program 200.

In this specification, the robot movement control program 200 can mean software including instructions for controlling the movement of the robot by referring to the boarding position coordinates of the robot determined by considering the weight distribution of the internal space of the elevator based on the sensing data of the internal space of the elevator obtained by using sensors mounted on the elevator and the robot.

The processor 110 can load the robot movement control program 200 and the information for executing the robot movement control program 200 from the memory 130 in order to execute the robot movement control program 200.

The processor 110 can determine whether the robot boards the elevator based on the first sensing data acquired for the internal space of the elevator using a camera sensor and a weight sensor of the elevator, and when the robot boards the elevator, determine a first boardable area of the robot based on the first sensing data and second sensing data acquired for the internal space of the elevator using the lidar sensor mounted on the robot, determine a second boardable area of the robot from the first boardable area by considering the weight distribution for the internal space of the elevator, and control the movement of the robot by referring to the boarding position coordinates of the robot determined from the second boardable area.

In an example implementation, the robot can mean an autonomous driving robot that drives on at least one floor, area, or space constituting a specific building and performs a predetermined task (e.g., delivery, cleaning, etc.).

In an example implementation, the elevator can mean an intelligent elevator utilizing IoT sensors, AI, and cloud computing, etc., and can provide real-time data analysis, automatic optimization, and user-customized services.

In an example implementation, the building can mean an intelligent building utilizing technology such as IoT sensors, AI, and automation systems. In some examples, the building can be linked to a data cloud system centered on building information modeling (BIM) data, and can share updated information with the robot and the elevator in real time through real-time monitoring of the internal and external environments of the building.

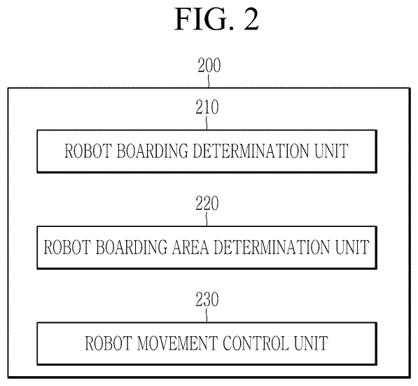

The functions and/or operations of the robot movement control program 200 will be described in detail with reference to FIG. 2.

FIG. 2 is a block diagram conceptually illustrating a function of a robot movement control program.

Referring to FIG. 2, the robot movement control program 200 can include a robot boarding determination unit 210, a robot boardable area determination unit 220, and a robot movement control unit 230.

The robot boarding determination unit 210, the robot boardable area determination unit 220, and the robot movement control unit 230 illustrated in FIG. 2 conceptually divide the functions of the robot movement control program 200 in order to easily describe the functions of the robot movement control program 200, but are not limited thereto. In some implementations, the functions of the robot boarding determination unit 210, the robot boardable area determination unit 220, and the robot movement control unit 230 can be merged/separated, and implemented as a series of instructions included in a single program.

In some implementations, the robot boarding determination unit 210 can determine whether the robot can be on board based on the first sensing data acquired for the internal space of the elevator using the camera sensor and the weight sensor of the elevator.

In some examples, the first sensing data can include image data for an object included in the elevator acquired through the camera sensor (e.g., an RGB camera, an infrared camera, a spectrum camera, etc.) and weight data for the object acquired using the weight sensor (e.g., a load cell-based weight sensor, a piezoelectric sensor, etc.).

Specifically, the robot boarding determination unit 210 can compare a sum of a weight of an object included in the elevator and a weight of the robot acquired using the weight sensor with a loadable weight of the elevator to determine whether the robot can be on board.

For example, when the loadable weight of the elevator is 3000 kg, the weight of the object included in the elevator is 1500 kg, and the weight of the robot is 100 kg, the robot boarding determination unit 210 can determine whether the robot can board the elevator.

In some examples, the robot boarding determination unit 210 can determine whether the robot can board by referring to the category and position of the object determined from the image of the object acquired using the camera sensor of the elevator. For instance, the category of the object can include classification such as human, animal, package, etc.

In some implementations, the category and position of the object can be determined through a pre-trained object detection model (e.g., Fast R-CNN model, OpenPose model, etc.) based on training images for the object and a pose and angle of the camera sensor.

For example, the pre-trained object detection model can be trained to input training images (e.g., images of pre-processed objects based on adaptive transformation to the pose and angle of the camera sensor) of pre-processed objects from images of multiple objects, and output the categories, bulks (or volumes), number, and positions of objects included in the elevator.

Specifically, the robot boarding determination unit 210 can determine whether the robot can board the internal space of the elevator based on the volume and position according to the categories of objects detected through the pre-trained object detection model and the volume of the robot.

For example, when considering the volume and position according to the categories of objects included in the elevator, if the volume of the robot exceeds the volume of the remaining space in the internal space of the elevator, the robot boarding determination unit 210 can determine that the robot is not permitted to board the elevator.

That is, it can be determined whether the robot can be on board based on the allowable boarding weight in the elevator, and it can be secondarily determined whether the robot can be on board based on the allowable boarding volume in the elevator, thereby improving the accuracy of the determination of the possibility of boarding the robot.

In some examples, when there is at least one boarding-waiting object for boarding the elevator, the robot boarding determination unit 210 can estimate the number of at least one boarding-waiting object and the weight of the boarding-waiting object using the camera sensor mounted on the robot.

For example, the robot boarding determination unit 210 can input 3D data on the boarding-waiting object acquired using the camera sensor to a deep learning model (e.g., MLP or PointNet) to estimate the volume of the boarding-waiting object and the weight corresponding to the volume. In some examples, the deep learning model can mean a model that has trained the correlation between the volume and weight of the object.

In addition, the robot boarding determination unit 210 can determine whether the robot can board by comparing the sum of the weight of the estimated at least one boarding-waiting object, the weight of the object included in the elevator, and the weight of the robot with the loadable weight of the elevator.

In some examples, the robot boarding determination unit 210 can determine whether the robot can be on board by considering the volume according to the category of the boarding-waiting object, the volume according to the category of the object included in the elevator, and the volume of the robot.

In some examples, the robot boarding determination unit 210 can determine whether the robot can board by further considering the number of boarding-waiting objects and the boarding order.

Hereinafter, the description will be given on the assumption that the robot can board the elevator.

In some implementations, the robot boardable area determination unit 220 can determine the first boardable area of the robot based on the first sensing data and the second sensing data acquired for the internal space of the elevator using the lidar sensor mounted on the robot.

In some examples, the first boardable area can mean an area in the elevator where the robot can physically board.

In addition, the second sensing data can include distance data, three-dimensional shape data, and position data for the object included in the elevator acquired through the lidar sensor.

Specifically, the robot boardable area determination unit 220 can re-determine the position of the object based on the distance between the robot and the object included in the elevator acquired using the lidar sensor mounted on the robot.

More specifically, the robot boardable area determination unit 220 can re-determine the position of the object through matching between the first position data for the object included in the elevator determined based on the camera sensor of the elevator and the second position data determined based on the lidar sensor mounted on the robot.

For example, when the first position coordinate of the object included in the elevator determined based on the camera sensor of the elevator and the second position coordinate of the object included in the elevator determined based on the lidar sensor mounted on the robot do not match, the robot boardable area determination unit 220 can request the elevator or the robot to reconfirm the position of the object until the estimated positions of the object match using the camera sensor of the elevator and the lidar sensor of the robot.

In addition, when the positions of the object match, the robot boardable area determination unit 220 can determine the first boardable area of the robot by referring to the re-determined position and category of the object.

In some examples, the robot boardable area determination unit 220 can determine the second boardable area of the robot from the first boardable area by considering the weight distribution of the internal space of the elevator.

In some examples, the second boardable area can mean an area that allows the load balance of the object included in the elevator to be maintained after the robot boards the elevator.

In some examples, the floor area of the internal space of the elevator can include at least one weight sensing area divided into a preset size. For example, the floor area of the elevator can include nine weight sensing areas divided into the same area, and the weight of the object in each area can be measured using the weight sensor of the elevator.

Specifically, the robot boardable area determination unit 220 can determine, from the first boardable area, an area corresponding to a weight lower than the average or minimum object weight of the object weights measured in each of at least one weight sensing area as the second boardable area.

For example, the second boardable area can be expressed as in the following mathematical Equation 1.

$$f ( x , y ) = \{ \begin{matrix}0 , & if ( f ( x , y ) > mean ( f ( x , y ) ) \\ 1 , & otherwise\end{matrix} \qquad Equation 1$$

In some examples, f(x, y) can mean the weight of the object in each weight sensing area, mean (f(x,y)) can mean the average of the object weights measured in each weight sensing area, and an area where f(x,y) is 1 can mean the second boardable area.

In this way, by precisely determining the area where the robot can physically and safely board the elevator by referring to the weight, category, and position of the estimated object using both the elevator sensor and the robot sensor, the efficiency of robot control for boarding with other objects can be improved.

In some implementations, the robot movement control unit 230 can control the movement of the robot by referring to the boarding position coordinates of the robot determined from the second boardable area.

Specifically, the robot movement control unit 230 can determine the boardable position coordinates of the robot so that the centers of gravity for the object and robot included in the elevator are included in the center area of the elevator.

In some examples, when a horizontal length of the elevator is L and a vertical length is H, the center area of the elevator can mean a rectangular area determined as L/3×H/3.

The structure and size of the center area of the elevator are only examples, and can be variously changed within the scope that can achieve the purpose of the present disclosure by referring to the design structure of the elevator, etc.

In addition, the robot movement control unit 230 can determine the position coordinates included in the second boardable area among the boardable position coordinates of the robot as the boarding position coordinates of the robot.

In this way, by considering the centers of gravity of the object and robot included in the elevator, the effect of enabling safe operation of the elevator can be achieved by determining the boarding position coordinates of the robot.

In some examples, the robot movement control unit 230 can determine the boarding position coordinates of the robot by further considering a disembarking floor of the robot and a disembarking floor of the previously input elevator.

For example, when the disembarking floor of the previously input elevator is higher than the disembarking floor of the robot, the robot movement control unit 230 can determine the position coordinate closest to the entrance among the boardable position coordinates of the robot as the boarding position coordinates of the robot.

For another example, when the disembarking floor of the previously input elevator is lower than the disembarking floor of the robot, the robot movement control unit 230 can determine the position coordinate farthest to the entrance among the boardable position coordinates of the robot as the boarding position coordinates of the robot.

However, determining the boarding position coordinates of the robot based on the distance from the entrance is only an example, and can be variously changed within the scope that can achieve the purpose of the present disclosure.

In some examples, the robot movement control unit 230 can provide robot movement information to the object included in the elevator through at least one of a speaker and a display mounted on the robot.

In some examples, the robot movement information can include information on whether the robot is on board, a movement path for moving to the boarding position coordinates of the robot, and information on the disembarking floor of the robot.

For example, when the robot is not on board, the robot movement control unit 230 can provide an indication of difficulty in boarding to an object included in the elevator through at least one of the speaker and display mounted on the robot.

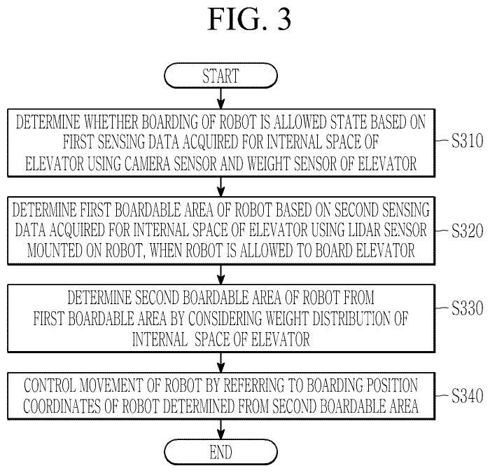

FIG. 3 is a flowchart illustrating a method of controlling movement of a robot using an elevator.

Referring to FIG. 3, the robot boarding determination unit 210 can determine whether the robot can be on board based on the first sensing data acquired for the internal space of the elevator using the camera sensor and the weight sensor of the elevator (S310).

In some examples, the first sensing data can include image data for an object included in the elevator acquired through the camera sensor (e.g., an RGB camera, an infrared camera, a spectrum camera, etc.) and weight data for the object acquired using the weight sensor (e.g., a load cell-based weight sensor, a piezoelectric sensor, etc.).

In some examples, the robot boardable area determination unit 220 can determine the first boardable area of the robot based on the first sensing data and the second sensing data acquired for the internal space of the elevator when the robot can board the elevator (S320).

In some examples, the second sensing data can include distance data, three-dimensional shape data, and position data for the object included in the elevator acquired through the lidar sensor.

In some implementations, the robot boardable area determination unit 220 can determine the second boardable area of the robot from the first boardable area by considering the weight distribution of the internal space of the elevator (S330).

In some implementations, the robot movement control unit 230 can control the movement of the robot by referring to the boarding position coordinates of the robot determined from the second boardable area (S340).

In some examples, the robot movement control unit 230 can determine the boarding position coordinates of the robot by considering the centers of gravity of the object and the robot included in the elevator.

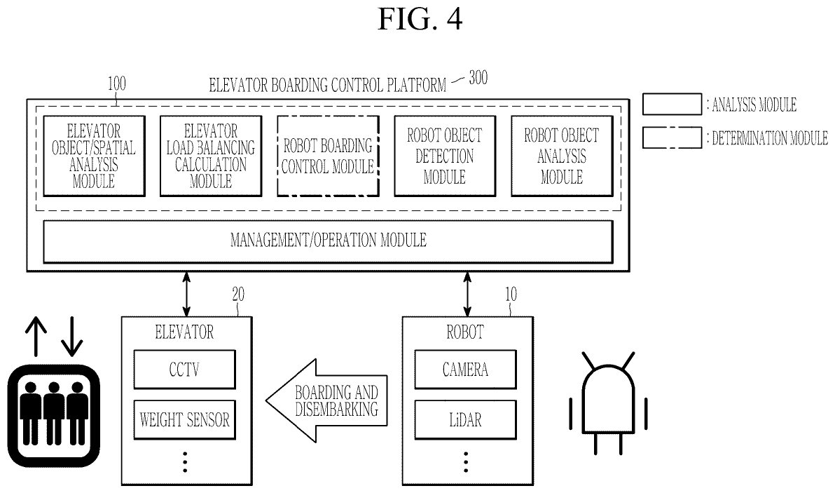

FIG. 4 is a diagram exemplarily illustrating a structure of an elevator boarding control system.

Referring to FIG. 4, the elevator boarding control system can include a robot 10, an elevator 20, and an elevator boarding control platform 300 that is linked to the robot 10 and the elevator 20. The apparatus 100 for controlling movement of a robot can be linked to the elevator boarding control platform 300 or can be built into the robot 10. Hereinafter, the description will be made based on the premise that the apparatus 100 for controlling movement of a robot is linked to the elevator boarding control platform 300.

The elevator boarding control platform 300 can include an analysis module and a determination module.

Specifically, the analysis module can include an elevator object/space analysis module for identifying the remaining space in the internal space of the elevator based on the object and space analysis in the elevator, an elevator load balancing calculation module for recognizing the weight distribution on the floor area of the elevator using the weight sensor and the camera sensor of the elevator, a robot object detection module for performing recognition and detection inference on a specific object of the robot and converting the inference results of the recognition and detection into a DB, and a robot object analysis module for analyzing the flow, pattern, complexity, rule, etc., of the object by synthesizing the sensing data on the position and object of the robot.

In addition, the determination module can include a robot boarding control module for controlling the robot's boarding of the elevator by synthesizing the data acquired from the elevator and the data acquired from the robot.

The apparatus 100 for controlling movement of a robot can determine whether the robot can be on board using the elevator object/space analysis module. In addition, the apparatus 100 for controlling movement of a robot can determine the first boardable area of the robot by further using the robot object detection module and the robot object analysis module. In addition, the apparatus 100 for controlling movement of a robot can determine the second boardable area of the robot from the first boardable area by using the elevator load balancing calculation module. In addition, the apparatus 100 for controlling movement of a robot can control the movement of the robot based on the boarding position coordinates of the robot determined from the second boardable area by using the robot boarding control module.

The robot 10 can include an avoidance module, a movement strategy module, and a sensor (e.g., a camera, a lidar, etc.). In some examples, the robot 10 can transmit sensing data acquired through the sensor to an elevator boarding control platform 300, and can receive a boarding/disembarking control command from the elevator boarding control platform 300. In addition, the robot 10 can be controlled to board at the boarding position coordinates of the robot and disembark from the boarding position coordinates of the robot using the movement strategy module.

The elevator 20 can include a CCTV camera sensor and a weight sensor. In some examples, the elevator 20 can transmit sensing data acquired through the sensor to the elevator boarding control platform 300, and receive a sensing control command from the elevator boarding control platform 300. In some examples, the elevator 20 can further include a sensor for detecting the category and position of an object, such as a CO2 sensor, a voice sensor, and a temperature sensor, in addition to the CCTV camera sensor and the weight sensor.

In some examples, when the sensing data acquired from the robot 10 is not transmitted to the elevator boarding control platform 300 (i.e., in the case of robot communication deterioration), the elevator boarding control platform 300 can transmit a boarding/disembarking control command to the robot 10 using only the sensing data acquired from the elevator 20.

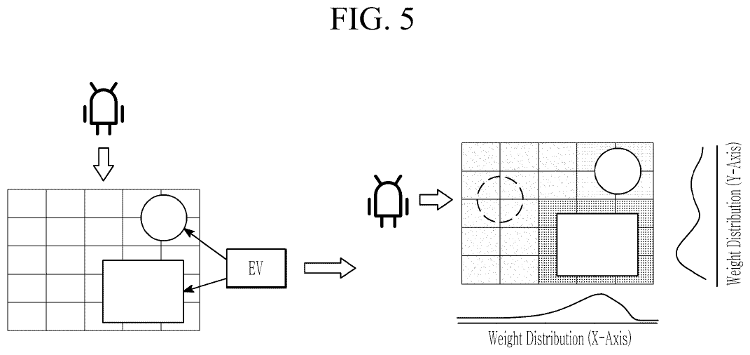

FIG. 5 is a diagram illustrating an example of determining whether boarding of a robot is allowed and determining a boardable area of the robot.

FIG. 5 illustrates a first circular object and a second rectangular object included in the internal space of the elevator.

Referring to FIG. 5, the robot boarding determination unit 210 can determine whether the robot can board based on weight data for the first object and the second object acquired using the weight sensor of the elevator.

In addition, the robot boarding determination unit 210 can determine whether the robot can board by referring to the category and position of the first object and the category and position of the second object, which are determined based on the image data of the first object and the second object acquired using the camera sensor of the elevator.

In some examples, when the robot can board the elevator, the robot boardable area determination unit 220 can re-determine the category and position of the first object and the second object based on distance data and shape data of the first object and the second object acquired using the lidar sensor mounted on the robot.

In addition, the robot boardable area determination unit 220 can determine the first boardable area of the robot by referring to the re-determined category and position of the first object and the second object.

In addition, the robot boardable area determination unit 220 can determine the second boardable area of the robot from the first boardable area by considering the weight distribution of the first object, the second object, and the robot.

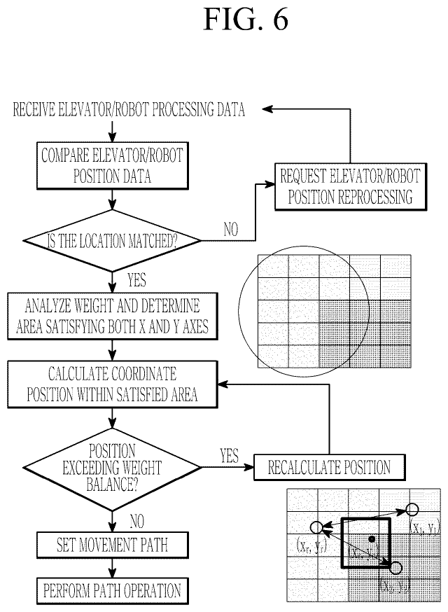

FIG. 6 is a diagram illustrating an example of controlling movement of a robot by referring to boardable position coordinates of the robot in which a center area of the elevator is determined to include centers of gravity of an object and the robot included in the elevator.

Referring to FIG. 6, the apparatus 100 for controlling movement of a robot can receive position data of an object included in the elevator from the elevator boarding control platform, and compare first position data of an object inferred based on sensing data sensed from the elevator and second position data of an object inferred based on sensing data sensed from the robot.

In some examples, when the first position data and the second position data do not match, the apparatus 100 for controlling movement of a robot can request the elevator or the robot to reprocess the position data inference.

In some examples, when the first position data and the second position data match, the apparatus 100 for controlling movement of a robot can determine the boardable area of the robot, which is an area satisfying both the x-axis and the y-axis, by considering the weight distribution determined based on the weight analysis for the object included in the elevator.

In some examples, the floor area of the internal space of the elevator includes at least one weight sensing area divided into a preset size, and the position coordinates of each of the weight sensing areas can be set based on the orthogonal coordinate system.

In addition, the apparatus 100 for controlling movement of a robot can determine the boardable position coordinates such that the centers of gravity of the object and the robot included in the elevator are included in the center area of the elevator. In some examples, when the centers of gravity of the object and the robot are not included in the center area of the elevator, the apparatus 100 for controlling movement of a robot can recalculate the boardable position coordinates of the robot.

In addition, the apparatus 100 for controlling movement of a robot can determine the position coordinates included in the boardable area among the boardable position coordinates of the robot as the boarding position coordinates of the robot.

In some examples, the apparatus 100 for controlling movement of a robot can set a movement path by referring to the boarding position coordinates of the robot, and the robot can perform the path operation.

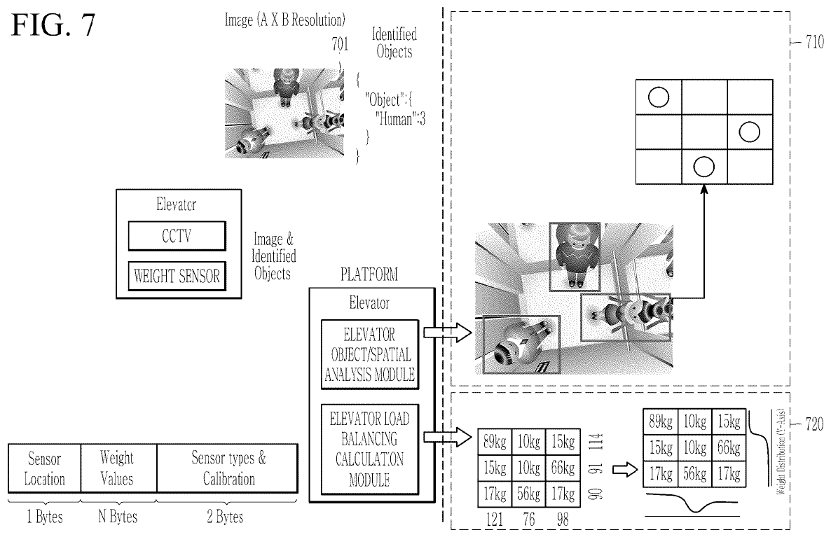

FIG. 7 is a diagram illustrating an example of determining a position of an object included in an elevator and a weight distribution of the object through linkage between the elevator and an elevator boarding control platform.

Referring to FIG. 7, object classification data (e.g., the category and number of objects included in the elevator (i.e., human: 3), etc.) determined from image data 701 acquired using a CCTV camera sensor mounted on the elevator can be transmitted to the elevator boarding control platform.

In addition, weight data (e.g., number, position, category, adjustment setting, measurement result, etc. of weight sensors) acquired using the weight sensor mounted on the elevator can be transmitted to the elevator boarding control platform.

In addition, the apparatus 100 for controlling movement of a robot can determine the position of the object included in the elevator using an elevator object/space analysis module 710.

Specifically, the elevator object/space analysis module can perform camera position-based object display and floor area-based angle calculation from the image data 701, and determine the position of the object included in the elevator by considering the calculated angle and camera position.

In addition, the apparatus 100 for controlling movement of a robot can analyze the weight included in the elevator using an elevator load balancing calculation module 720.

Specifically, the elevator load balancing calculation module can determine the weight distribution of the object included in the elevator based on the weight measured for each weight sensing area constituting the floor area of the elevator.

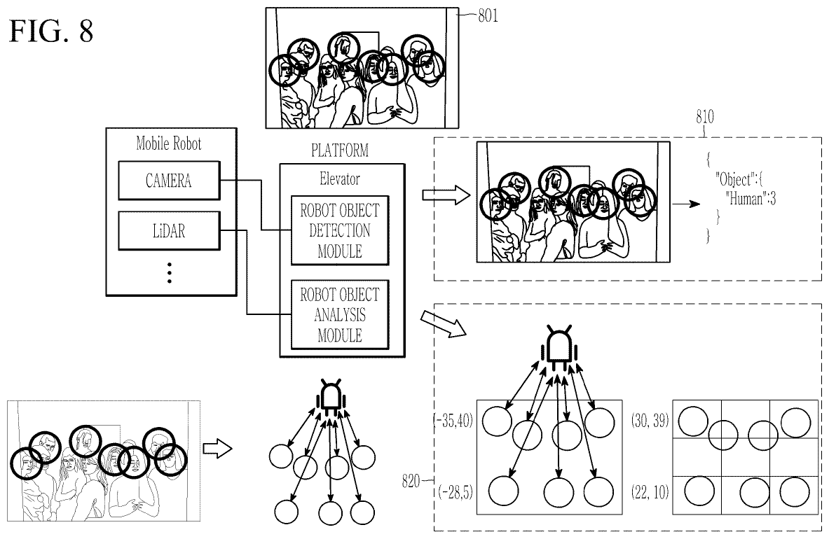

FIG. 8 is a diagram illustrating an example of re-determining the position of the object included in the elevator through linkage between the robot and the elevator boarding control platform.

Referring to FIG. 8, image data 801 acquired using a camera sensor mounted on the robot can be transmitted to the elevator boarding control platform.

In addition, object-specific distance data acquired using the lidar sensor mounted on the robot can be transmitted to the elevator boarding control platform.

In addition, the apparatus 100 for controlling movement of a robot can determine the category and number of objects included in the elevator using the robot object detection module 810. For instance, the robot object detection module can determine the category and number of objects (e.g., human: 10, animal: 0) detected from the image data 801.

In addition, the apparatus 100 for controlling movement of a robot can determine the position of the object included the elevator using the robot object analysis module 820.

Specifically, the robot object analysis module can determine the position coordinates of each object based on the distance data for each object and match the determined position coordinates with the position coordinates of the floor area of the elevator.

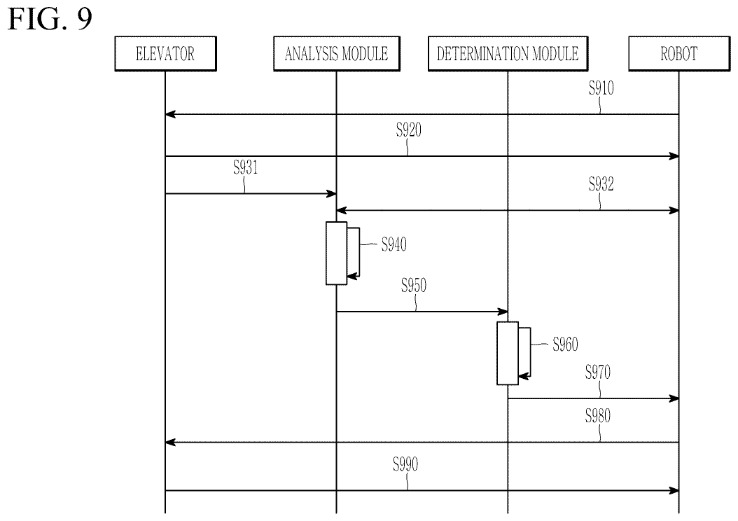

FIG. 9 is a diagram illustrating an example of controlling the movement of the robot using the elevator based on the linkage between the elevator, the robot, and the elevator boarding control platform.

Referring to FIG. 9, when the robot transmits an API call request signal for boarding the elevator to the elevator (S910), the elevator can transmit a response signal to the robot (S920).

In some examples, the elevator transmits the first sensing data acquired from the elevator to the analysis module (S931), and the robot can transmit the second sensing data acquired as the door of the elevator opens to the analysis module (S932).

In some examples, the analysis module can process data on whether the robot is on board and the boardable area of the robot based on the first sensing data and the second sensing data (S940).

In some examples, the analysis module can transmit data on whether the robot is on board and the boardable area of the robot to the determination module (S950), and the determination module can determine the boarding position coordinates of the robot from the data on whether the robot is on board and the boardable area, and generate transmission data related thereto (S960).

In some examples, when the determination module transmits the transmission data to the robot (S970), the robot can transmit data on whether the robot is on board and the boarding position to the elevator (S980).

In some examples, the elevator can receive data on whether the elevator is available for boarding and the boarding position, generate the response signal, and transmit the generated response signal to the robot (S990), and the robot can be controlled according to the boarding position coordinates.

Combinations of each block of the block diagram and each step of the accompanying flow chart attached to the present disclosure can also be performed by computer program instructions. Since these computer program instructions can be mounted in an encoding processor of a general computer, a special computer, or other programmable data processing apparatuses, these computer program instructions executed through the encoding processor of the computer or the other programmable data processing apparatuses create means performing functions described in each block of the block diagram or each step of the flow chart. Since these computer program instructions can also be stored in a computer usable or computer readable memory of a computer or other programmable data processing apparatuses in order to implement the functions in a specific scheme, the computer program instructions stored in the computer usable or computer readable memory can also produce manufacturing articles including instruction means performing the functions described in each block of the block diagram or each step of the flow chart. Since the computer program instructions can also be mounted on the computer or other programmable data processing devices, instructions that perform a series of operational steps on a computer or other programmable data processing devices to produce a computer-executed process and perform the computer or other programmable data processing device can also provide steps for performing the functions described in each block of the block diagram and each step of the flowchart.

In addition, each block or each step can indicate some of modules, segments, or codes including one or more executable instructions for executing a specific logical function (specific logical functions). Further, it is to be noted that functions mentioned in the blocks or the steps occur regardless of a sequence in some alternative implementations. For example, two blocks or steps that are continuously shown can be simultaneously performed in fact or be performed in a reverse sequence depending on corresponding functions.

The spirit of the present disclosure has been illustratively described hereinabove. It will be appreciated by a person of ordinary skill in the art that various modifications and alterations can be made without departing from the essential characteristics of the present disclosure. Accordingly, the example implementations disclosed in the present disclosure are not to limit the spirit of the present disclosure, but are to describe the present disclosure, and the scope of the present disclosure is not limited by the example implementations. The scope of the present should be interpreted by the following claims, and it should be interpreted that all spirits equivalent to the following claims fall within the scope of the present disclosure.

What is claimed is:

1. A method for controlling movement of a robot at an elevator, comprising:
obtaining first sensing data of an internal space of the elevator using a camera sensor of the elevator and a weight sensor of the elevator;
determining whether the robot is permitted to board the elevator based on the first sensing data;
obtaining second sensing data of the internal space of the elevator using a lidar sensor disposed at the robot;
based on the robot boarding the elevator, determining a first boardable area for the robot based on the first sensing data and the second sensing data;
determining a second boardable area for the robot from the first boardable area based on a weight distribution of the internal space of the elevator;
determining boarding position coordinates of the robot from the second boardable area; and
controlling the movement of the robot based on the boarding position coordinates.

2. The method of claim 1, wherein determining whether the robot is permitted to board the elevator comprises:
comparing a sum of a weight of one or more objects in the elevator acquired using the weight sensor and a weight of the robot, with a weight capacity of the elevator to thereby determine whether the robot is permitted to board the elevator.

3. The method of claim 2, wherein determining whether the robot is permitted to board the elevator comprises:
determining a category and a position of the one or more objects from an image of the one or more objects acquired using the camera sensor of the elevator; and
determining whether the robot is permitted to board the elevator based on the category and the position of the one or more objects.

4. The method of claim 3, wherein the category and the position of the one or more objects are determined through a pre-trained object detection model based on a training image for the one or more objects and a pose and an angle of the camera sensor.

5. The method of claim 2, wherein determining whether the robot is permitted to board the elevator comprises:
determining whether at least one boarding-waiting object is present for boarding the elevator;
based on the at least one boarding-waiting object being present for boarding the elevator, estimating a weight of the at least one boarding-waiting object using a camera sensor disposed at the robot; and
comparing a sum of the weight of the at least one boarding-waiting object, the weight of the object in the elevator, and the weight of the robot with the weight capacity of the elevator to thereby determine whether the robot is permitted to board the elevator.

6. The method of claim 1, wherein determining the first boardable area comprises:
determining, using the lidar sensor of the robot, a distance between the robot and an object in the elevator;
determining a position of the object in the elevator based on the distance between the robot and the object; and
determining the first boardable area based on the position of the object and a category of the object.

7. The method of claim 1, wherein a floor area of the internal space of the elevator includes at least one weight sensing area having a preset size, and
wherein determining the second boardable area comprises:
measuring object weights in each of the at least one weight sensing area; and
determining, from the first boardable area, a region of the floor area corresponding to a weight that is less than an average or a minimum of the object weights.

8. The method of claim 1, wherein controlling the movement of the robot comprises:
determining boardable position coordinates of the robot such that centers of gravity of one or more objects in the elevator and the robot fall within a central area of the elevator; and
determining, from among the boardable position coordinates, position coordinates that are included in the second boardable area, as the boarding position coordinates of the robot.

9. The method of claim 8, wherein determining the boarding position coordinates comprises:
determining the boarding position coordinates of the robot based on (i) a disembarking floor of the robot and (i) a disembarking floor of the elevator that is previously input.

10. The method of claim 1, wherein controlling the movement of the robot comprises:
providing robot movement information to an object in the elevator through at least one of a speaker or a display disposed at the robot, the robot movement information including (i) a movement path to the boarding position coordinates of the robot and (ii) a disembarking floor of the robot.

11. An apparatus for controlling movement of a robot at an elevator, comprising:
a processor; and
a memory storing a robot movement control program configured to, based on being executed by the processor, cause the apparatus to perform operations comprising:
obtaining first sensing data of an internal space of the elevator using a camera sensor of the elevator and a weight sensor of the elevator,
determining whether the robot is permitted to board the elevator based on the first sensing data,
obtaining second sensing data of the internal space of the elevator using a lidar sensor disposed at the robot,
based on the robot boarding the elevator, determining a first boardable area for the robot based on the first sensing data and the second sensing data,
determining a second boardable area for the robot from the first boardable area based on a weight distribution of the internal space of the elevator,
determining boarding position coordinates of the robot from the second boardable area, and
controlling the movement of the robot based on the boarding position coordinates.

12. The apparatus of claim 11, wherein determining whether the robot is permitted to board the elevator comprises:
comparing a sum of a weight of one or more objects in the elevator acquired using the weight sensor and a weight of the robot, with a weight capacity of the elevator to thereby determine whether the robot is permitted to board the elevator.

13. The apparatus of claim 12, wherein determining whether the robot is permitted to board the elevator comprises:
determining a category and a position of the one or more objects from an image of the one or more objects acquired using the camera sensor of the elevator; and
determining whether the robot is permitted to board the elevator based on the category and the position of the one or more objects.

14. The apparatus of claim 12, wherein determining whether the robot is permitted to board the elevator comprises:
determining whether at least one boarding-waiting object is present for boarding the elevator;
based on the at least one boarding-waiting object being present for boarding the elevator, estimating a weight of the at least one boarding-waiting object using a camera sensor disposed at the robot; and
comparing a sum of the weight of the at least one boarding-waiting object, the weight of the object in the elevator, and the weight of the robot with the weight capacity of the elevator to thereby determine whether the robot is permitted to board the elevator.

15. The apparatus of claim 11, wherein determining the first boardable area comprises:
determining, using the lidar sensor of the robot, a distance between the robot and an object in the elevator;
determining a position of the object in the elevator based on the distance between the robot and the object; and
determining the first boardable area based on the position of the object and a category of the object.

16. The apparatus of claim 11, wherein a floor area of the internal space of the elevator includes at least one weight sensing area having a preset size, and
wherein determining the second boardable area comprises:
measuring object weights in each of the at least one weight sensing area; and
determining, from the first boardable area, a region of the floor area corresponding to a weight that is less than an average or a minimum of the object weights.

17. The apparatus of claim 11, wherein controlling the movement of the robot comprises:
determining boardable position coordinates of the robot such that centers of gravity of one or more objects in the elevator and the robot fall within a central area of the elevator; and
determining, from among the boardable position coordinates, position coordinates that are included in the second boardable area, as the boarding position coordinates of the robot.

18. The apparatus of claim 17, wherein determining the boarding position coordinates comprises:
determining the boarding position coordinates of the robot based on (i) a disembarking floor of the robot and (i) a disembarking floor of the elevator that is previously input.

19. The apparatus of claim 11, wherein the operations further comprise:
providing robot movement information to an object in the elevator through at least one of a speaker or a display disposed at the robot, the robot movement information including (i) a movement path to the boarding position coordinates of the robot and (ii) a disembarking floor of the robot.

20. A non-transitory computer-readable recording medium storing a computer program,
wherein the computer program includes instructions configured to, based on being executed by a processor, cause the processor to perform operations for controlling movement of a robot at an elevator, the operations comprising: obtaining first sensing data of an internal space of the elevator using a camera sensor of the elevator and a weight sensor of the elevator,
determining whether the robot is permitted to board the elevator based on the first sensing data,
obtaining second sensing data of the internal space of the elevator using a lidar sensor disposed at the robot,
based on the robot boarding the elevator, determining a first boardable area for the robot based on the first sensing data and the second sensing data,
determining a second boardable area for the robot from the first boardable area based on a weight distribution of the internal space of the elevator,
determining boarding position coordinates of the robot from the second boardable area, and
controlling the movement of the robot based on the boarding position coordinates.
